(19) United States
(12) Patent Application Publication
(10) Pub. No.: US 2005/0194010 A1
(43) Pub. Date: Sep. 8, 2005

(54) Disposable contagion transmission prevention device and method of using a disposable contagion transmission prevention device

(76) Inventor: Philip W. Sankot, Centreville, VA (US)

Correspondence Address: HARNESS, DICKEY & PIERCE, P.L.C., P.O. BOX 8910, RESTON, VA, 20195, US

(21) Appl. No.: 10/793,012

(22) Filed: Mar. 5, 2004

(51) Int. Cl. A62B 23/02; A62B 18/08

(52) U.S. Cl. 128/206.19; 128/206.12; 128/205.27

(57) ABSTRACT

A disposable personal contagion transmission prevention device for preventing transmission of airborne contagions may include a device body having an exterior and interior surface and shaped so as to provide a sealing fit over the bridge of a user's nose, extending downward along the cheek lines beneath the user's chin so as to sealingly enclose a user's mouth and nose within an interior cavity formed by the device body over the face. The device body may also include a bulbous protrusion that is contiguous with the device body and extends outward from the device body to provide a handhold for facilitating the placing of the device body over and against the nose bridge, cheeks and chin of the user. The interior surface of the device body with bulbous protrusion may include an absorbent fibrous material that entrains fluids and particulate that may be forcefully expelled from the user.

### BACKGROUND OF THE INVENTION

1. Field of the Invention

The present invention relates to a disposable personal contagion transmission prevention device that may prevent passage of airborne aerosols, particulate matter and/or liquids that a person may emit from the nose and mouth to the general shared outside atmosphere.

2. Related Art

Disposable facemasks have been manufactured for many years, traditionally for preventing contamination of patients by liquids and particulate from the mouth and nose emitted from a healthcare worker, or vice versa. More recently, increased use of disposable face masks has been evident in the airline industry, due to the threat of spread of airborne contagions like Severe Acute Respiratory Syndrome (SARS) or Tuberculosis.

Primarily, a person wears a mask to prevent him or her from coming into contact with such airborne contagions emitted by others around them or in the vicinity of their person. In addition to protecting the user from airborne contagions, such masks may protect the person from other types of contagions and irritants such as airborne dust, airborne viruses that may cause symptoms ranging from the common cold to infectious mononucleosis, as well as airborne hydrocarbons entrained in recirculated air on an aircraft, for example.

However, many of these masks are inefficient in that they are subject to blow by, a situation in which a mask may momentarily part from the face of the user as the user sneezes, thereby allowing at least some airborne or particulate matter effluent from the mouth or nose to leak out. What is desired is a disposable mask that a user may employ to contain their own expelled liquid and/or particulate matter so as not to release potentially harmful airborne contagions into the general shared atmosphere around them, perhaps adversely infecting nearby people.

### SUMMARY OF THE INVENTION

An exemplary embodiment of the present invention is directed to a disposable personal contagion transmission prevention device for preventing transmission of airborne contagions. The device may include a device body shaped so as to provide a sealing fit over the bridge of the user's nose, extending downward along the cheek lines beneath the user's chin so as to sealingly enclose a user's mouth and nose within an interior cavity formed by the device body over the face. The device body may include a centrally located pronounced bulbous protrusion that is contiguous with the device body and extends outward from the device body to provide a hand hold or finger hold for facilitating the placing of the device body against the nose bridge, cheeks and chin. The device body with bulbous protrusion may have an exterior and an interior surface or surfaces. The interior surfaces may be composed of an absorbent fibrous material that such that it may entrain airborne fluids that may be forcefully expelled by the user, while allowing the forced air to pass through.

Another exemplary embodiment of the present invention is directed to a method of protecting against personal transmission of airborne contagions by employing the disposable personal a disposable contagion transmission prevention device. A user may grasp the device body by the bulbous protrusion so that an inner surface of the device body and bulbous protrusion is placed over the nose and mouth of the user. The device body and bulbous protrusion may be applied over and against the nose and mouth so as to provide a sealing fit over the bridge of a user's nose extending downward along the cheek lines and beneath the user's chin to sealingly enclose the user's mouth and nose. The user may then forcefully expel bodily fluids into the interior of the device body and bulbous protrusion, which may efficiently entrain these potential contagions for disposal, rather than allowing the forcefully expelled particulate to be released in the general, shared atmosphere.

### BRIEF DESCRIPTION OF THE DRAWINGS

Exemplary embodiments of the present invention will become more fully understood from the detailed description given herein below and the accompanying drawings, wherein like elements are represented by like reference numerals, which are given by way of illustration only and thus are not limitative of the exemplary embodiments of the present invention and wherein:

FIG. 1 is a front view of the disposable personal contagion transmission prevention device in accordance with an exemplary embodiment of the present invention.

FIG. 2 is a rear-view of the disposable personal contagion transmission prevention device of FIG. 1.

FIG. 3 is a side view of the disposable personal contagion transmission prevention device of FIG. 1.

FIG. 4A illustrates a cross section taken along line A-A of FIG. 3 to describe an exemplary material layer structure of the device body 1 in accordance with an exemplary embodiment of the present invention.

FIG. 4B illustrates a cross section taken along line A-A of FIG. 3 to describe another exemplary material layer structure of the device body 1.

FIG. 4C illustrates a cross section taken along line B-B of FIG. 4 to describe a multi-ply embodiment of one of the membranes of FIG. 4.

FIGS. 5A and 5B are rear-views of a personal disposable contagion transmission prevention device in accordance with another exemplary embodiment of the present invention.

FIG. 6 is a side view of a disposable personal contagion transmission prevention device in accordance with another exemplary embodiment of the present invention.

FIG. 7 is a side view of a disposable personal contagion transmission prevention device in accordance with another exemplary embodiment of the present invention.

FIG. 8 is a side view of a disposable personal contagion transmission prevention device in accordance with another exemplary embodiment of the present invention.

### DETAILED DESCRIPTION OF THE EXEMPLARY EMBODIMENTS

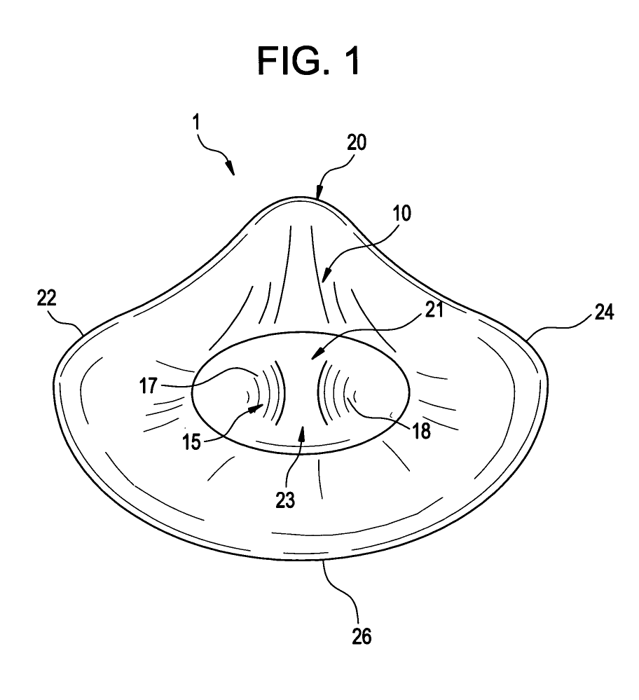

Referring to FIG. 1, the personal disposable contagion transmission prevention device 1 may include a device body 10 that contains a centrally located pronounced bulbous protrusion 15. When the device 1 is pressed over and against the mouth and nose of the user, a cavity (not shown) may be formed between an inner surface of the device body 10 and the face (not shown) as formed between the nose, face and interior hollow bulbous protrusion and the interior side of the bulbous protrusion 15). As shown in FIG. 1, the device 1 may be shaped so as to follow the general contours of a person's face. For example, an upper edge surface 20 is designed to rest against the bridge of a user's nose, lateral edge surfaces 22 and 24 may extend down and outwardly along the face to trace cheek lines of the user and to terminate at a lower portion of the device 1 over the user's chin, shown generally at bottom edge surface 26.

As to be described in detail hereafter, the device body 10 may be held over and against the user's mouth and nose by the user grasping the bulbous protrusion 15. To facilitate grasping of the bulbous protrusion 15, indentations 17 and 18 may be provided on an outer surface of the device body 1 in the vicinity of bulbous protrusion 15, as shown in FIG. 1, for example. Although indentations 17 and 18 are shown in side-to side relation along a horizontal axis of the bulbous protrusion 15, these indentations may be provided at an upper end 21 and a lower end 23 of the bulbous protrusion 15 (i.e., along a vertical axis) for example, to provide an alternative handhold. Alternatively, in other exemplary embodiments, suitable attachment means may be provided, should the user elect or be directed to wear the device 1 for any length or period of time.

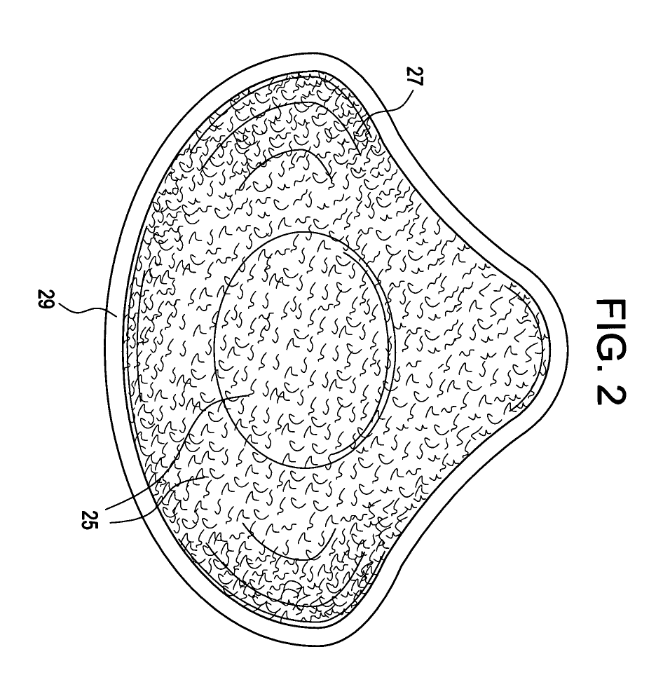

FIG. 2 is a rear-view of the personal protection device of FIG. 1. Referring to FIG. 2, in this exemplary embodiment, the device body 1 may include a continuous sealing surface 29 for a desired sealing fit against the user's nose bridge, cheeks and chin. Additionally, the interior portion(s) of the device 1 (generally shown at 25) that is to receive the user's forced air and airborne, particulate and liquid effluent may be comprised of an absorbent fibrous material allowing for the flow of air while preventing the transmission of liquid and particulate 27 that may line the interior portion(s) 25 of the device body 10 and bulbous protrusion 15, but which would be of such a thickness as to permit a cavity to be formed between the lip/nose and inner surfaces of the device body 10 and bulbous protraction 15. The absorbent fibrous material 27 may be comprised of layers of filtering materials, for example. Accordingly, the device 1 may be characterized as an “off-the-face” protection device.

The dimensions of the bulbous protrusion 15 may be designed so as to be substantially in line with a user's mouth, instead of the user's nose. Accordingly, the bulbous protrusion 15 further enables a cavity to be formed between the user's nose and mouth when the device 1 is ion place against the face of the user, so as to provide an expelling area allowing the user to cough and/or sneeze, while not restricting normal breathing operations. Moreover, the materials forming one or more of the device body 10/bulbous protrusion 15 and absorbent fibrous material 27 may be designed so as to allow vapors (such as inhaled air, exhaled CO₂, etc.,) to pass into and out of the device 1, while entraining potential airborne particulate or liquid contagions from being released into the atmosphere.

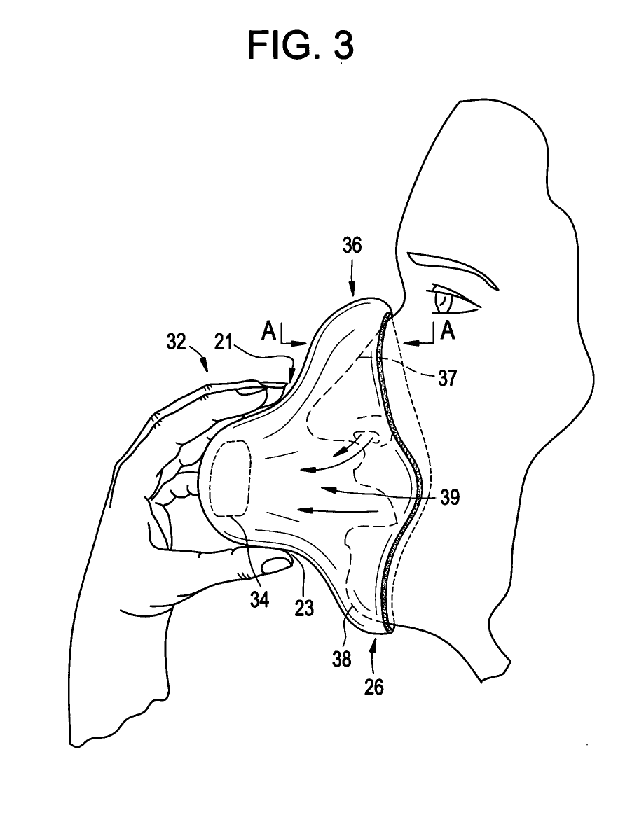

FIG. 3 is a side view of the personal protection device of FIG. 1. FIG. 3 is provided to illustrate a method by which a user may protect against personal transmission of airborne contagions by utilizing the personal disposable contagion transmission prevention device described herein. Referring to FIG. 3, the user may initially grasp the device 1 by the bulbous protrusion 15 as is shown at 32, for example. As described earlier, the bulbous protrusion may include indentations 17 or 18, or at 21 and 23 for ease of grasping, as shown in FIG. 1. Optionally, the bulbous protrusion 15 may further include a central opening (shown at 34 in dotted line format) that allows the user to lock one or more fingers there through to securely grasp the device 1.

After grasping the device by indentations or through a central opening, the user then applies the device body 10 over and against the user's face, aligning the bulbous protrusion 15 with the mouth so that the upper end 36 of the device 1 rests over the bridge 37 of a user's nose, and so that the lower edge surface 26 fits over the chin 38 of the user, as shown in FIG. 3. When properly mounted upon and held against the user's face, a central inner cavity 39 may be formed between the absorbent fibrous material 27 on the device body 10 inner surface and the user's nose and mouth. Accordingly, as the user expels bodily fluids such as particulate matter, liquids and/or other airborne matter outward, the absorbent fibrous material 27 on the inner surface of the device body 10 entrains the liquid and prevents it from escaping, while allowing the air, or gas to flow through at a significantly reduced speed. As the device 1 may include a continuous sealing surface 29, a seal may be formed around the user's face in order to provide sufficient sealing for the device 1 there around during the coughing, sneezing of effluent expelling episode. Thereafter, the device 1, designed so as to be as disposable, may be discarded (if desired) into a suitable container or trash receptacle, or hazardous material receptacle for example.

The device body 10 and bulbous protrusion 15 may have an outer shell that may be formed of a reasonably rigid material to maintain a form that relates to the general contours of the face (nose bridge, cheeks and chin) yet of a material that also has at least some elasticity. Exemplary materials for the outer shell may be pressed and molded cotton, paper or other cellulose-like material that has at least some degree of elasticity. The absorbent fibrous material 27 described herein may be fixedly adhered (by stitching, sealing, adhesives or other known manufacturing processes for securing two materials) to an inner surface of the outer shell. The absorbent fibrous material 27 may be embodied as one or several individual layers of materials that may have at least some aspect of elasticity. In an exemplary embodiment, the absorbent fibrous material 27 may be one or more material layers having filtering characteristics.

For example, the fibrous absorbent material 27 may be a non-irritating, non-allergen fibrous material such as cotton. Cotton may exhibit a characteristic of elasticity to at least partially yield to the force of a sneeze or cough, so as to catch potentially contagious viral or bacterial particulate and liquid. The fibrous material may be in woven form and stitched to an inner surface of the device body 1 or otherwise securely sealed to an inner surface of device body 1 and bulbous protrusion 15 by known manufacturing processes, for example.

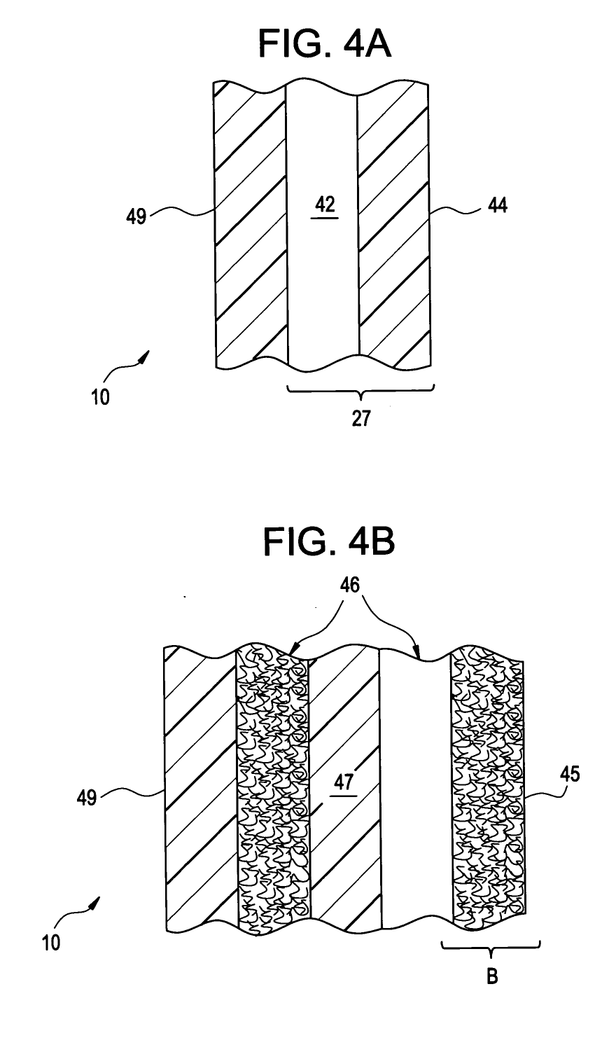

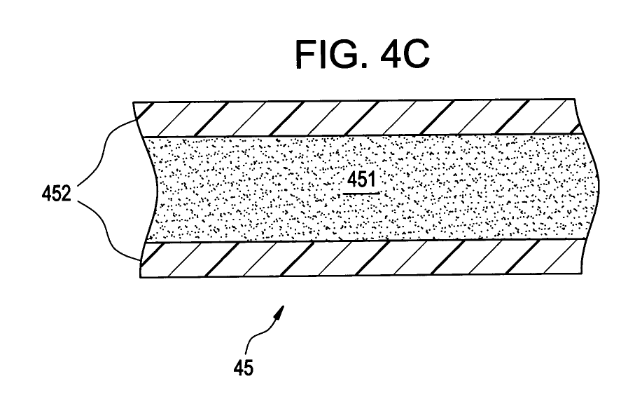

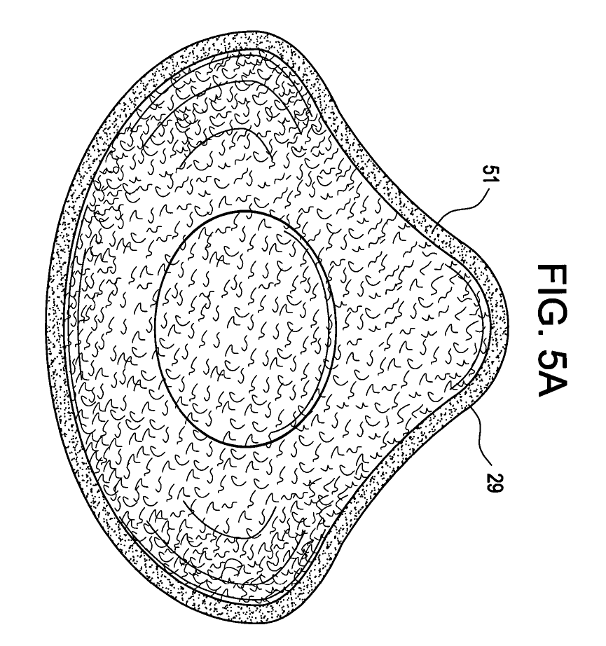

FIG. 4A illustrates a cross section taken along line A-A of FIG. 3 to describe an exemplary material layer structure of the device body 1 in accordance with an exemplary embodiment of the present invention. The absorbent fibrous material 27 may be configured as a one or more material layers. Referring to FIG. 4A, a filter media layer 42 of melted blown polypropylene and an inner facing layer 44 of spun bonded polypropylene, tissue, or cellulose material may form a pair of layers comprising the absorbent fibrous material 27. If desired, a third, outer facing layer which forms the outer shell 49 of the device body 1 may be made out of a suitable spun bonded polypropylene, for example, or another type of filter layer.

FIG. 4B illustrates a cross section taken along line A-A of FIG. 3 to describe another exemplary material layer structure of the device body 1. Alternatively, the absorbent fibrous material 27 may be made up of a combination of multiple filtering membranes interleaved with absorbent fibrous material layers such as cotton. Each of these membranes may have characteristics of elasticity so as to return to an original shape after being subject to the force of a cough or sneeze, for example.

For example, in FIG. 4B, an inner membrane 45 positioned closer to the user's mouth may be provided for filtering out the larger particles (on the order of 10-15 microns for example, or larger) in some bacteria of other germs expelled by the user, and an outer membrane 47 may provide entrapment of smaller airborne contaminants (on the order of 3 microns or less, for example) which pass through the inner membrane 45. Between the outer membrane 47 and inner membrane 45 may be a layer of fibrous material such as cotton, shown in FIG. 4B as layer 46.

FIG. 4C illustrates a cross section taken along line B-B of FIG. 4 to describe a multi-ply embodiment of one of the membranes of FIG. 4. The inner membrane 45 (or outer membrane 47) may itself be configured as a plurality of filtering media layers, i.e., a multi-ply filtering membrane. For example, as shown in FIG. 4C, membrane 45 may be constructed of a pair of polyolefin outer layers 452 sandwiching a polyolefin maze 451, for example, it being understood that suitable materials other than polyolefin could be used for the multi-ply inner membrane 45, such as one or more micro porous films or a network of fibers that allow for vapor transmission while preventing the transmission of airborne particulates. The polyolefin maze 451 allows air to freely pass but entraps airborne contaminants, so as to provide effective entrapment of small particle contaminants. By entrapping such particulate, the polyolefin maze 451 may effectively block undesirable airborne contaminants expelled from a user using device 1.

The outer membrane 47 may include a suitable filter area for entrapping smaller contaminants which pass through the inner membrane 45. If desired, additional absorbent fibrous layers 46 may be provided between the outer and inner membranes, or between the outer membrane 47 and device body outer shell 49, so as to add additional absorbing characteristics to the device 1.

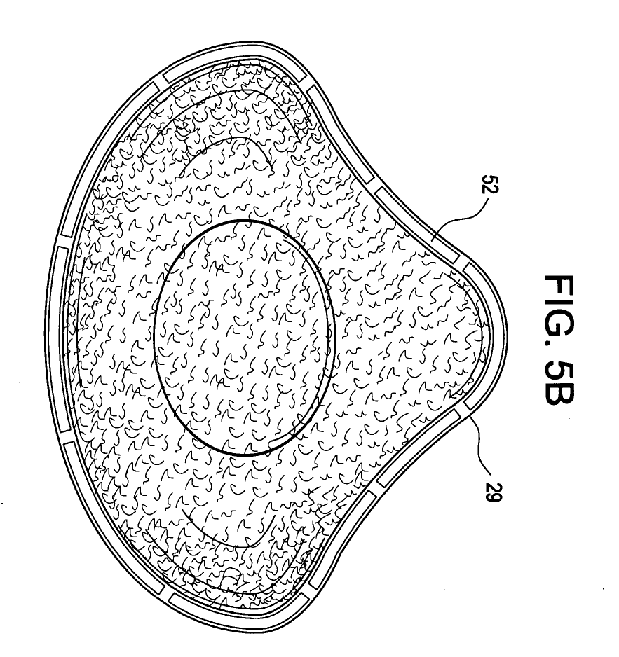

FIGS. 5A and 5B are rear-views of a disposable personal contagion transmission prevention device in accordance with another exemplary embodiment of the present invention. The aforementioned exemplary embodiments describe a situation where the user grasps the device 1 by the bulbous protrusion 15 and places the device 1 over his or her face temporarily to expel particulate and/or liquid airborne matter. However, there may be a situation where the user is substantially ill (knows this as a fact or perceives this to be the case) and wants to wear the device 1 for extensive lengths of time so as to avoid potentially infecting people around him or her.

Referring to FIGS. 5A and 5B, the exemplary embodiments offer a strapless embodiment. As shown in FIG. 5A the continuous sealing surface 29 may be provided with a continuous adhesive coating 51 so as to enable the mask to adhere directly to the user's nose, cheeks and chin. Although continuous sealing surface 29 with adhesive coating 51 provide a continuous adhesive strip member around the outer peripheral of the device 1, the device 1 may alternatively have truncated adhesive strips 52, as shown in FIG. 5B, for example.

The continuous adhesive coating 51 or adhesive strips 52 may be made of a strip material such as a bidirectional elastic adhesive tape applied to the outside surface. For example, the bidirectional elastic adhesive tape may comprise 3M elastic non-woven tape available from 3M Healthcare with the adhesive side contacting the wearer's face, providing the tight seal. The bidirectional stretch nature of the tape permits the wearer to change facial expressions (such as is the case during a coughing, sneezing or bodily fluid expelling episode) and speak readily, without comprising the seal.

Alternatively, the adhesive strips 52 or continuous adhesive coating 51 may be composed of a skin-adhering, hydrogel type material. Strips of a skin-adhesive hydrogel may be applied directly to the skin but allow the skin to breath. These are just a few of the possible adhesives that may be utilized for attaching the adhesive strips 52 or continuous adhesive strip member (formed by providing a continuous adhesive coating 51 on sealing surface 29) which are on the outer periphery of the device body 10, to the user's face.

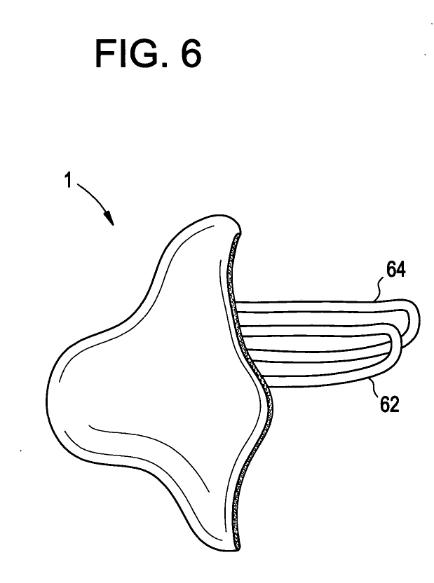

FIG. 6 is a side view of a disposable personal contagion transmission prevention device in accordance with another exemplary embodiment of the present invention. FIG. 6 illustrates a device 1 similar to that shown in FIG. 3, but illustrates more traditional attachment means may be provided, should the user elect to wear the device 1 for any length or period of time. As shown in FIG. 6, the device 1 may include a pair of elastic ear loops 62 and 64, made for example of polyester and lycra ultrasonically bounded to the device body 10 of the device 1, although other elastic materials may substitute for lycra and polyester as is known in the art. The ear loops 62 and 64 may be similar to ear loops employed in some styles of traditional pleated-type face masks worn in any hospital today.

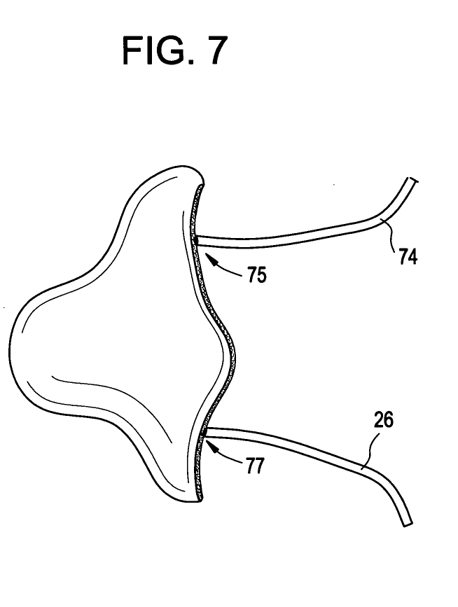

FIG. 7 is a side view of a disposable personal contagion transmission prevention device in accordance with another exemplary embodiment of the present invention. FIG. 7 illustrates one side of the device 1, on which is provided a pair of tying elements generally designated at 74 and 76 attached at two locations of the device body 1, shown generally on one side at 75 and 77. A corresponding set of ties is one the other side of device 1 (not shown for clarity). The tying elements 74 and 76 may take the form of two conventional ties, which during use are tied to corresponding tying elements on the other side of device 1 by means of a suitable knot such as a bow knot, for example, above the head and around the neck. It is within the skill of the art to substitute a pair of elastic bands for the tying elements such that one elastic band may be extended over the upper back of the head, and the other elastic band extended around the neck or in the vicinity of a lower part of the back of the head, as is available with currently available surgical masks.

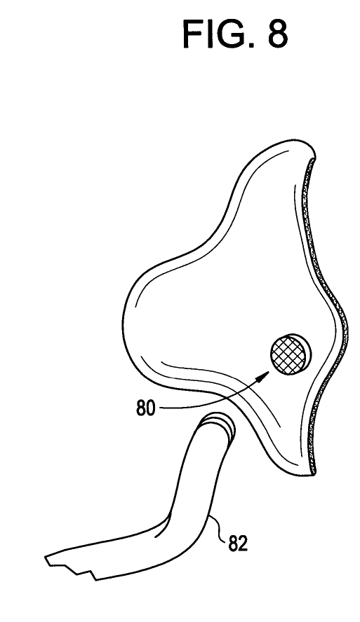

FIG. 8 is a side view of a disposable personal contagion transmission prevention device in accordance with another exemplary embodiment of the present invention. The device 1 may be adapted or configured to include a suitable connector for connection to an oxygen supply, such as an oxygen supply hose or line that is in the overhead of a passenger aircraft. For example, the device 1 may optionally include a connector 80 for connecting to an oxygen supply line (shown generally at 82). Connector 80 may be applicable to any of the above-described exemplary embodiments. The oxygen connector 80 may be fabricated as part of the device 1, for example. The connector 80 may be embodied by a suitable flange and ring arrangement such as is described in FIG. 3 of U.S. Pat. No. 5,709,204 to Lester, incorporated herein by reference, so as to allow a person to breathe in oxygen and exhale while the oxygen supply line 82 is connected, and to continue to breathe and exhale through the device 1 after the oxygen supply line 82 has been removed, for example. However, connector 80 may be embodied by other suitable structures or materials, so long as the connector 80 is arranged so as to have at least some network of absorbent fibers or material that allows for vapor transmission, such as oxygen, to pass, while preventing the transmission of airborne particulates (when the oxygen line 82 is not attached).

Accordingly, the device body and bulbous protrusion in accordance with the exemplary embodiments may be applied over and against the nose and mouth so as to provide a sealing fit, so that the user may forcefully expel bodily fluids into the interior of the device body and bulbous protrusion, which may substantially entrain these potential contagions for disposal, rather allowing the forcefully expelled particulate to release in the general shared atmosphere. Simultaneously, the design and of the device may enable the device to ‘yield’ somewhat so as to allow passage of air through the device, while potentially substantially reducing the probability that others in the general vicinity of the user will be infected with the user's contagion(s).

The exemplary embodiments of the present invention being thus described, it will be obvious that the same may be varied in many ways. Such variations are not to be regarded as departure from the spirit and scope of the exemplary embodiments of the present invention, and all such modifications as would be obvious to one skilled in the art are intended to be included within the scope of the following claims.

1. A disposable personal contagion transmission prevention device for preventing transmission of airborne contagions, comprising:
a device body having an outer surface and an interior surface, the device body shaped so as to provide a sealing fit over the bridge of a user's nose, extending downward from the nose bridge along cheek lines and terminating beneath a user's chin so as to sealingly enclose a user's mouth and nose; and
a bulbous protrusion contiguous with the device body and extending generally outward from a central location on the outer surface of the device body to provide a handhold for facilitating placing of the device body against the nose bridge, cheeks and chin, the interior surface of the device body with bulbous protrusion including an absorbent fibrous material that entrains fluids and particulate expelled from the user.

2. The device of claim 1, wherein the bulbous protrusion includes a pair of indentations to facilitate handling the device.

3. The device of claim 1, wherein the indentations are configured in side-by-side relation on the bulbous protrusion as viewed along a horizontal axis of the bulbous protrusion.

4. The device of claim 1, wherein the indentations are configured in a vertical stacked relation on the bulbous protrusion as viewed along a vertical axis of the bulbous protrusion.

5. The device of claim 1, wherein the device body maintains a seal around the nose bridge, cheeks and chin due to an externally applied pressure on the bulbous protrusion of the device body.

6. The device of claim 1, wherein the external pressure is applied by the hand of the user.

7. The device of claim 1, wherein the device body maintains a seal around the nose bridge, cheeks and chin after release by the user.

8. The device of claim 1, wherein
the device body has a continuous sealing surface that extends around an outer periphery of the device body, and
the continuous sealing surface is adapted to directly contact the user's nose bridge, cheeks and chin to provide a sealing fit.

9. The device of claim 8, wherein the continuous sealing surface includes a continuous adhesive strip that is adapted to sealingly mate with the user's nose bridge, cheeks and chin.

10. The device of claim 9, wherein
the continuous adhesive strip includes one of a bidirectional elastic adhesive tape material and a skin-adhering hydrogel material so as to sealingly mate with the user's nose bridge, cheeks and chin.

11. The device of claim 1, further comprising:
attachment means for enabling the device body to maintain a seal around the nose bridge, cheeks and chin after release by the user.

12. The device of claim 11, wherein the attachment means is one of a continuous adhesive strip applied to a sealing surface that extends around an outer periphery of the device body, a pair of ear loops, and a pair of tying elements to secure the device to the user's head.

13. The device of claim 1, wherein
the device body with bulbous protrusion is composed of a pliable outer shell, and one or more inner absorbent fibrous material layers, and
the fibrous material has a filtering characteristic so as to entrain particulate and fluid matter containing airborne contagions therein, and a breathability characteristic that enables vapor passage through the fibrous material layers and outer shell.

14. The device of 1, wherein the fibrous material is comprised of one or more layers of gas permeable filter media to prevent passage of liquid and particulate matter to an outside, generally shared atmosphere.

15. The device of claim 1, wherein the bulbous protrusion includes an opening that facilitates holding of the device body against the nose bridge, cheeks and chin.

16. The device of claim 1, further comprising:
a connector attached to the device body for connection with an external oxygen supply.

17. A method of protecting against personal transmission of airborne contagions by employing a disposable personal contagion transmission prevention device, the device including a device body having a bulbous protrusion thereon providing a handhold, the method comprising:
grasping the device body by the bulbous protrusion so that an inner surface of the device body and bulbous protrusion is placeable against the face of a user;
applying the device body over and against the face, the device body shaped so as to provide a sealing fit over the bridge of a user's nose, extending downward from the nose bridge along cheek lines and terminating beneath a user's chin so as to sealingly enclose a user's mouth and nose;
expelling internal bodily fluids and particulate matter into an interior of the device body and bulbous protrusion, the interior composed of a non-irritating, absorbent fibrous material that entrains the expelled fluids.

18. The method of claim 1, wherein the device allows for passage of air there through at a reduced rate, as the device entrains the expelled fluids.

19. The method of claim 17, further comprising:
removing the device from the face when expulsion of bodily fluids is complete; and discarding the device.

20. The method of claim 17, further comprising:
maintaining the device in place around the nose bridge, cheeks and chin for subsequent expulsions of bodily fluids, after release of the bulbous protrusion by the user.

21. The method of claim 20, wherein said maintaining step is facilitated by a continuous adhesive strip provided on a sealing surface of the device body that extends along an outer periphery around the device body, the continuous adhesive strip sealingly mating with the user's nose bridge, cheeks and chin.

22. The method of claim 17, wherein the fibrous material has a filtering characteristic so as to entrain particulate and fluid matter potentially containing airborne contagions therein, and a breathability characteristic that enables vapor passage through the fibrous material.
